(19) United States
(12) Patent Application Publication
(10) Pub. No.: US 2002/0171771 A1
(43) Pub. Date: Nov. 21, 2002

(54) Phase correction circuit, signal discrimination circuit, phase correction method and signal discrimination method

(75) Inventors: Yoshihiro Inada, Hyogo (JP); Shinji Yamashita, Hyogo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MITSUBISHI DENKI KABUSHIKI KAISHA, TOKYO (JP)

(21) Appl. No.: 10/118,128

(22) Filed: Apr. 9, 2002

(30) Foreign Application Priority Data
May 16, 2001 (JP) 2001-146293

(51) Int. Cl. H04N 9/66

(52) U.S. Cl. 348/638; 348/641

(57) ABSTRACT

An absolute-value difference arithmetic section obtains an absolute-value difference from a first component and a second component. A component discriminating section or a signal discriminating section (circuit) discriminates an inputted chroma signal by phase discrimination and distance discrimination using the absolute-value difference. A correction executing section corrects the phase of the inputted chroma signal using the absolute-value difference. The absolute-value difference arithmetic section is formed by an adder and/or a subtracter on a small circuit scale.

### BACKGROUND OF THE INVENTION

1. Field of the Invention

The present invention relates to a phase correction circuit, a signal discrimination circuit, a phase correction method and a signal discrimination method, and relates to a technique of facilitating discrimination of a signal having a predetermined component and correction of a phase of the signal on a small circuit scale.

2. Description of the Background Art

A chroma signal (or (carrier) chrominance signal) of a video signal is modulated using a carrier suppressed type quadrature two-phase balanced modulation system.

FIG. 24 is a block diagram showing a general chroma signal demodulation circuit 1P. The chroma signal demodulation circuit 1P includes two demodulators 1r and 1b. One of the demodulators 1r, to which a chroma signal c and a reference subcarrier having a 90° phase lead with respect to a subcarrier are inputted, demodulates a red color-difference signal (hereinafter also referred to as RY signal). The other modulator 1b, to which the input chroma signal c and a reference subcarrier being in phase with the subcarrier are inputted, demodulates a blue color-difference signal (hereinafter also referred to as BY signal). The RY and BY signals demodulated by the chroma signal demodulation circuit 1P are distributed on a (color) vector diagram of an orthogonal coordinate system shown in FIG. 25. At this time, an RY axis and a BY axis are orthogonal to each other.

In the chroma signal demodulation circuit 1P, giving the reference subcarrier to be inputted to the demodulator 1r a 100° phase lead with respect to the subcarrier and giving the reference subcarrier to be inputted to the demodulator 1b a 10° phase lag with respect to the subcarrier (see FIG. 26) cause the RY axis and the BY axis to be inclined toward the directions of 100° and −10° , respectively, as shown in the vector diagram of FIG. 27.

At this time, the locus of the unit vector on the vector diagram becomes an ellipse having an axis in the direction leading the subcarrier by 135° (see FIG. 27). Therefore, a component of the chroma signal having its phase near 135° is brought close to 135°. Since a vector having its phase near 135° corresponds to a skin color component, the chroma signal demodulation circuit 1P shown in FIG. 26 can cause a color component in the vicinity of a skin color component to approach the skin color component, so that the skin color is corrected.

In the chroma signal demodulation circuit 1P shown in FIG. 26, however, correction is inevitably carried out on a component in the fourth quadrant as well as the skin color component in the second quadrant.

### SUMMARY OF THE INVENTION

A first aspect of the present invention is directed to a phase correction circuit for correcting a phase of a signal. In the phase correction circuit, the signal is represented on a vector diagram of an orthogonal coordinate system having first and second coordinate axes by a signal vector having a first component on the first coordinate axis and a second component on the second coordinate axis. The phase correction circuit comprises: an absolute-value difference arithmetic section for obtaining an absolute-value difference corresponding to a difference between an absolute value of the first component and that of the second component; and a correction executing section for correcting the phase of the signal using the absolute-value difference, wherein the correction executing section includes: a correction amount arithmetic section for multiplying the absolute-value difference by a correction coefficient to obtain a correction amount; and a correction signal generating section for correcting the phase of the signal using the correction amount and the first and second components.

According to a second aspect of the present invention, in the phase correction circuit of the first aspect, the absolute-value difference arithmetic section includes at least one of a first adder adding the first and second components and a first subtracter calculating a difference between the first and second components, and the absolute-value difference arithmetic section obtains the absolute-value difference using at least one of an addition value obtained by the first adder and a subtraction value obtained by the first subtracter.

According to a third aspect of the present invention, in the phase correction circuit of the first or second aspect, the correction signal generating section includes either of a second adder adding the correction amount to the first or second component and a second subtracter subtracting the correction amount from the first or second component.

According to a fourth aspect of the present invention, the phase correction circuit of any one of the first to third aspects further comprises a component discriminating section for executing signal discrimination as to whether or not the phase of the signal should be corrected using the absolute-value difference, thereby controlling the correction executing section based on a result of the signal discrimination.

According to a fifth aspect of the present invention, in the phase correction circuit of the fourth aspect, the component discriminating section includes a comparing section for comparing the relation between an absolute value of the absolute-value difference and at least one comparative reference value.

According to a sixth aspect of the present invention, in the phase correction circuit of the fifth aspect, the at least one comparative reference value includes a plurality of comparative reference values, and the correction coefficient is variable in accordance with a comparison result given by the comparing section.

According to a seventh aspect of the present invention, in the phase correction circuit of the sixth aspect, the correction coefficient has a smaller absolute value corresponding to a greater one of the plurality of comparative reference values.

According to an eighth aspect of the present invention, in the phase correction circuit of any one of the fourth to seventh aspects, the component discriminating section includes a sign discriminating section for discriminating signs of the first and second components and the absolute-value difference, and the component discriminating section executes the signal discrimination using the signs of the first and second components and the absolute-value difference.

According to a ninth aspect of the present invention, in the phase correction circuit of any one of the fourth to eighth aspects, the signal discrimination includes at least one of phase discrimination as to whether or not the phase of the signal is present within a predetermined range of phase and distance discrimination as to whether or not an endpoint of the signal vector is present within a range of a predetermined distance from a correction axis.

According to a tenth aspect of the present invention, in the phase correction circuit of the ninth aspect, the predetermined distance includes a plurality of distances, and the correction coefficient has a smaller absolute value corresponding to a greater one of the plurality of distances.

According to an eleventh aspect of the present invention, in the phase correction circuit of any one of the first to tenth aspects, the signal includes a chroma signal, and the first coordinate axis includes a BY axis and the second coordinate axis includes an RY axis.

A twelfth aspect of the present invention is directed to a signal discriminating circuit for discriminating a signal. In the signal discriminating circuit, the signal is represented on a vector diagram of an orthogonal coordinate system having first and second coordinate axes by a signal vector having a first component on the first coordinate axis and a second component on the second coordinate axis. The signal discrimination circuit comprises: an absolute-value difference arithmetic section for obtaining an absolute-value difference corresponding to a difference between an absolute value of the first component and that of the second component; and a component discriminating section for executing signal discrimination as to whether or not the first and second components of the signal are present within a predetermined range using the absolute-value difference.

According to a thirteenth aspect of the present invention, in the signal discrimination circuit of the twelfth aspect, the component discriminating section includes a comparing section for comparing the relation between an absolute value of the absolute-value difference and at least one comparative reference value.

According to a fourteenth aspect of the present invention, in the signal discrimination circuit of the twelfth or thirteenth aspect, the component discriminating section includes a sign discriminating section for discriminating signs of the first and second components and the absolute-value difference, and the component discriminating section executes the signal discrimination using the signs of the first and second components and the absolute-value difference.

According to a fifteenth aspect of the present invention, in the signal discrimination circuit of any one of the twelfth to fourteenth aspects, the signal discrimination includes at least one of phase discrimination as to whether or not the phase of the signal is present within a predetermined range of phase and distance discrimination as to whether or not an endpoint of the signal vector is present within a range of a predetermined distance from a correction axis.

A sixteenth aspect of the present invention is directed to a phase correction method of correcting a phase of a signal. In the phase correction method, the signal is represented on a vector diagram of an orthogonal coordinate system having first and second coordinate axes by a signal vector having a first component on the first coordinate axis and a second component on the second coordinate axis. The phase correction method comprises the steps of: (a) obtaining an absolute-value difference corresponding to a difference between an absolute value of the first component and that of the second component; and (b) correcting the phase of the signal using said absolute-value difference, wherein the step (b) includes the steps of: (b-1) multiplying said absolute-value difference by a correction coefficient to obtain a correction amount; and (b-2) correcting the phase of the signal using the correction amount and the first and second components.

A seventeenth aspect of the present invention is directed to a discrimination method of discriminating a signal. In the discrimination method, the signal is represented on a vector diagram of an orthogonal coordinate system having first and second coordinate axes by a signal vector having a first component on the first coordinate axis and a second component on the second coordinate axis. The signal discrimination method comprises the steps of: (a) obtaining an absolute-value difference corresponding to a difference between an absolute value of the first component and that of the second component; and (b) executing signal discrimination as to whether or not the first and second components of the signal are present within a predetermined range using the absolute-value difference.

According to an eighteenth aspect of the present invention, the signal discrimination method of the seventeenth aspect further comprises the step of (c) comparing the relation between an absolute value of the absolute-value difference and at least one comparative reference value.

According to a nineteenth aspect of the present invention, the signal discrimination method of the seventeenth or eighteenth aspect further comprises the step of (d) discriminating signs of the first and second components and the absolute-value difference, wherein the step (b) includes the step of (b-1) executing the signal discrimination using the signs of the first and second components and the absolute-value difference.

In the circuit of the first aspect of the invention, the phase of a signal is corrected using the absolute-value difference. At this time, the absolute-value difference is basically obtainable by an adder and/or a subtracter. Further, since the correction amount is obtained by multiplying the absolute-value difference by the correction coefficient, no complicated formula is used. Therefore, the phase correction circuit can be provided on a small circuit scale.

In the circuit of the second aspect of the invention, the absolute-value difference is obtained using the adder and/or subtracter, which allows the absolute-value difference arithmetic section to be provided on a small circuit scale.

In the circuit of the third aspect of the invention, the correction signal generating section includes an adder and/or a subtracter, which allows the correction signal generating section to be provided on a small circuit scale.

The circuit of the fourth aspect of the invention can execute a facilitated signal discrimination using the absolute-value difference.

In the circuit of the fifth aspect of the invention, the absolute value of the absolute-value difference represents the distance between an endpoint of a signal vector and a correction axis, which makes it possible to execute discrimination (distance discrimination) as to whether or not the endpoint of the signal vector is present within a predetermined distance (corresponding to a comparative reference value) from the correction axis.

In the circuit of the sixth aspect of the invention, the correction coefficient, thus, a correction amount can be made variable in accordance with the distance between an endpoint of a signal vector and a correction axis, which allows reduction of discreteness (discontinuity) between a signal which is not a target of correction and a corrected signal.

In the circuit of the seventh aspect of the invention, the correction coefficient, thus, the correction amount has a smaller absolute value corresponding to a greater one of distances each between an endpoint of a signal vector and a correction axis. This can ensure minimization of discreteness between the above-described signals.

In the circuit of the eighth aspect of the invention, the signal discrimination is executed using the signs of the first and second components and the absolute-value difference, which allows to provide a component discriminating section capable of executing phase discrimination in 45° increments with respect to an origin point.

In the circuit of the ninth aspect of the invention, a signal to be corrected can be discriminated by means of the phase discrimination and/or distance discrimination.

In the circuit of the tenth aspect of the invention, the correction coefficient, thus, the correction amount has a smaller absolute value corresponding to a greater one of the distances each between an endpoint of a signal vector and a correction axis. This can ensure minimization of discreteness (discontinuity) between a signal which is not a target of correction and a corrected signal.

The phase correction circuit of the eleventh aspect of the invention can be utilized as a color (hue) correction circuit. Such a color correction circuit is capable of correcting a skin color.

In the circuit of the twelfth aspect of the invention, the signal discrimination is executed using the absolute-value difference. At this time, the absolute-value difference is basically obtainable by an adder and/or a subtracter. Therefore, the phase correction circuit can be provided on a small circuit scale.

In the circuit of the thirteenth aspect of the invention, the absolute value of the absolute-value difference represents a distance between an endpoint of a signal vector and a correction axis, which makes it possible to execute discrimination (distance discrimination) as to whether or not the endpoint of the signal vector is present within a predetermined distance (corresponding to a comparative reference value) from the correction axis.

In the circuit of the fourteenth aspect of the invention, the signal discrimination is executed using the signs of the first and second components and the absolute-value difference, which allows to provide the component discriminating section capable of executing the phase discrimination in 45° increments with respect to an origin point.

In the circuit of the fifteenth aspect of the invention, a signal can be discriminated by means of the phase discrimination and/or distance discrimination.

With the method of the sixteenth aspect of the invention, the phase of a signal is corrected using the absolute-value difference. At this time, the absolute-value difference is basically obtainable by an adder and/or a subtracter. Further, since the correction amount is obtained by multiplying the absolute-value difference by the correction coefficient, no complicated formula is used. This allows to provide a facilitated signal discrimination method.

With the method of the seventeenth aspect of the invention, the signal discrimination is executed using the absolute-value difference. At this time, the absolute-value difference is basically obtainable by an adder and/or a subtracter, which allows to provide a facilitated signal discrimination method.

With the method of the eighteenth aspect of the invention, the absolute value of the absolute-value difference represents the distance between an endpoint of a signal vector and a correction axis, which makes it possible to execute discrimination (distance discrimination) as to whether or not the endpoint of the signal vector is present within a predetermined distance (corresponding to a comparative reference value) from the correction axis.

With the method of the nineteenth aspect of the invention, the signal discrimination is executed using the signs of the first and second components and the absolute-value difference, which allows discrimination of the phase in 45° increments with respect to an origin point.

An object of the present invention is to provide a method of facilitating discrimination of a signal having a predetermined component and a method of facilitating correction of a phase of a signal as well as to provide a signal discrimination circuit and a phase correction circuit each on a small circuit scale in order to achieve these methods.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a phase correction circuit according to a first preferred embodiment of the invention;

FIGS. 2 to 4 are vector diagrams showing a phase correction method according to the first preferred embodiment;

FIG. 5 is a vector diagram showing a signal discrimination method according to the first preferred embodiment;

FIG. 6 is a block diagram showing an absolute-value difference arithmetic section according to the first preferred embodiment;

FIG. 7 is a block diagram showing another absolute-value difference arithmetic section according to the first preferred embodiment;

FIG. 8 is a block diagram showing an absolute-value difference arithmetic section for the second quadrant according to the first preferred embodiment;

FIG. 9 is a block diagram showing a component discriminating section according to the first preferred embodiment;

FIG. 10 is a block diagram showing a correction executing section according to the first preferred embodiment;

FIG. 11 is a vector diagram showing another signal discrimination method according to the first preferred embodiment;

FIG. 12 is a block diagram showing another absolute-value difference arithmetic section for the second quadrant according to the first preferred embodiment;

FIG. 13 is a block diagram showing another correction executing section according to the first preferred embodiment;

FIG. 14 is a vector diagram showing a phase correction method according to a second preferred embodiment of the invention;

FIG. 15 is a block diagram showing a distance discriminating section according to the second preferred embodiment;

FIG. 16 is a schematic signal waveform chart showing an operation of the distance discriminating section according to the second preferred embodiment;

FIG. 17 is a block diagram showing a correction executing section according to the second preferred embodiment;

FIG. 18 schematically shows an operation of a correction coefficient output section of the correction executing section according to the second preferred embodiment;

FIG. 19 is a vector diagram showing another phase correction method according to the second preferred embodiment;

FIG. 20 is a block diagram showing a phase correction circuit according to a first variation of the invention;

FIG. 21 is a block diagram showing a component discriminating section according to a second variation of the invention;

FIG. 22 is a block diagram showing another component discriminating section according to the second variation;

FIG. 23 is a vector diagram showing a phase correction method according to a third variation of the invention;

FIG. 24 is a block diagram showing a chroma signal demodulation circuit;

FIG. 25 is a vector diagram showing demodulation performed by the chroma signal demodulation circuit;

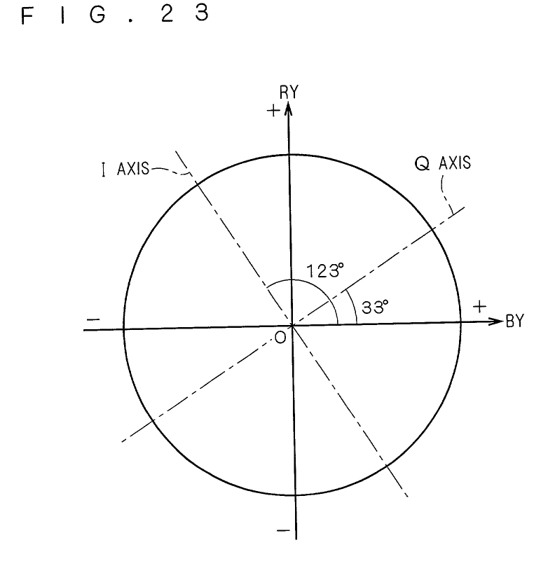

FIG. 26 is a block diagram of the chroma signal demodulation circuit for showing a conventional skin color correction method; and

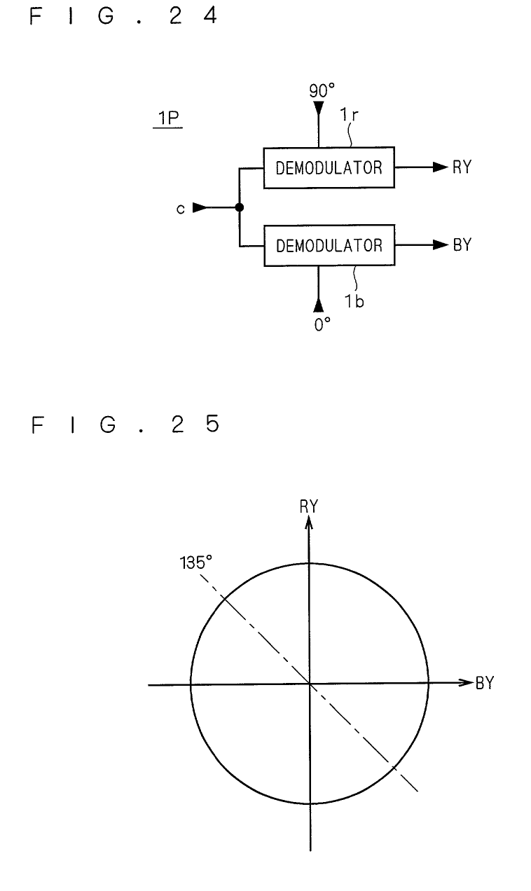

FIG. 27 is a vector diagram showing the conventional skin color correction method.

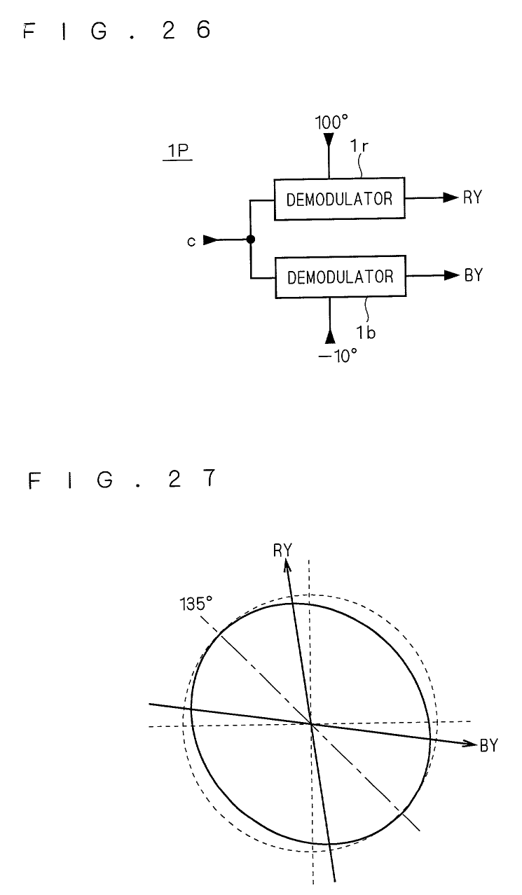

### DESCRIPTION OF THE PREFERRED EMBODIMENTS

<First Preferred Embodiment>

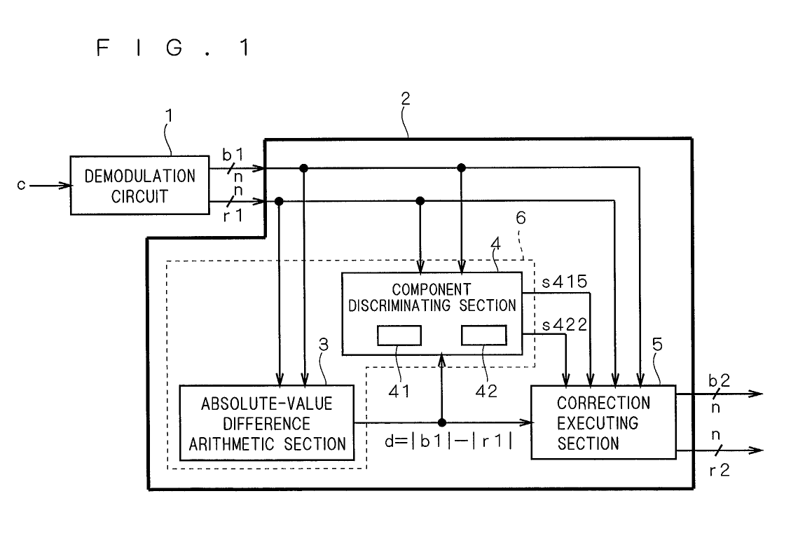

FIG. 1 is a block diagram showing a phase correction circuit (or color (hue) correction circuit) 2 according to the first preferred embodiment. A demodulation circuit 1 is also shown in FIG. 1 for the sake of explanation.

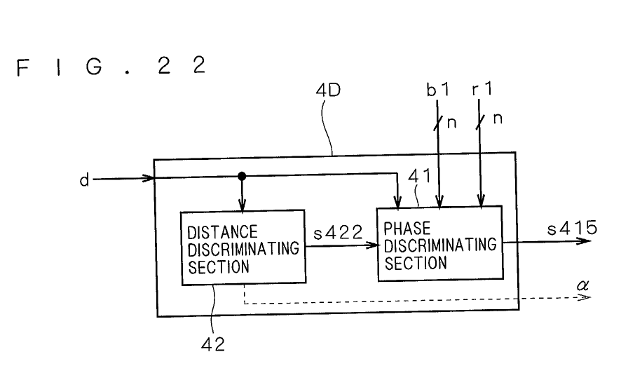

The demodulation circuit 1 demodulates a chroma signal (or (carrier) chrominance signal) c using two reference subcarriers with a phase difference of 90° therebetween and extracts a blue color-difference (hereinafter also referred to as BY) signal and a red color-difference (hereinafter also referred to as RY) signal. A common demodulation circuit such as the chroma signal demodulation circuit 1P shown in FIG. 24 is applicable to the demodulation circuit 1.

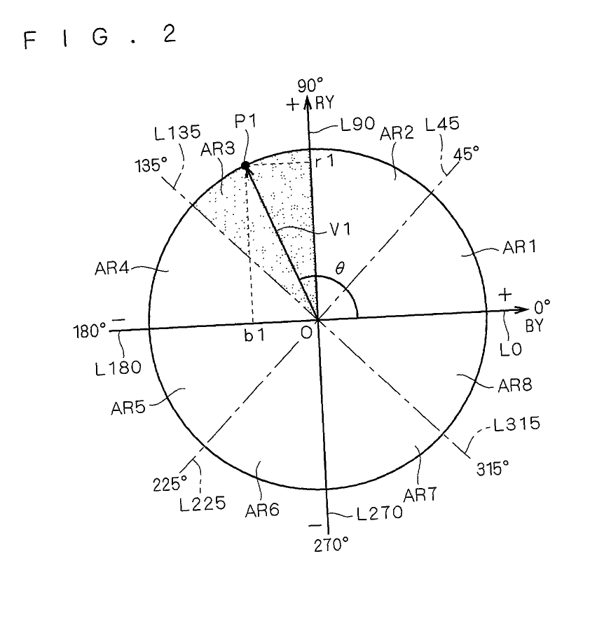

FIG. 2 is a (color) vector diagram showing a phase correction method, i.e., an operation of the phase correction circuit 2 according to the present embodiment. For representing the chroma signal c by vector on the vector diagram, an orthogonal coordinate system in which a first coordinate axis (horizontal axis in FIG. 2) and a second coordinate axis (vertical axis in FIG. 2) intersect at right angles at an origin point O of the coordinate system (hereinafter also briefly referred to as origin point).

The chroma signal c is represented on the vector diagram of the orthogonal coordinate system as a (color) vector (or signal vector) V1 starting at the origin point O, and a phase θ of the chroma signal c is given by an angle between the vector V1 and the positive direction of the first coordinate axis. At this time, an endpoint P1 of the vector V1 contains a first component b1 on the first coordinate axis (horizontal axis in this case) and a second component r1 on the second coordinate axis (vertical axis in this case). Reference characters b1 and r1 are also used to represent values of the components b1 and r1, respectively. The same applies to the character d to be described later, and the like.

An RY signal of the chroma signal c outputted from the demodulation circuit 1 has a phase lead of 90° with respect to a BY signal. Accordingly, a vector of the BY signal is defined in the positive direction of the first coordinate axis (horizontal axis) and a vector of the RY signal is defined in the positive direction of the second coordinate axis (vertical axis) in the vector diagram of FIG. 2. According to this diagram, the first component b1 corresponds to the BY signal and the second component r1 corresponds to the RY signal. In explanation hereinafter, the first coordinate axis and the second coordinate axis are also referred to as BY axis and RY axis, respectively, and the first component b1 and the second component r1 are also referred to as BY (color-difference) component (or BY (color-difference) signal) and RY (color-difference) component (or RY (color-difference) signal), respectively.

In the vector diagram of FIG. 2, an axis extending in the positive direction of the BY axis is referred to as axis L0, and axes L45, L90, L135, L180, L225, L270 and L315 are defined in the direction of the vector V1 when the phase θ forms angles of 45°, 90°, 135°, 180°, 225°, 270° and 315°, respectively. The axis L180 extends in the negative direction of the BY axis, and the axes L90 and L270 extend in the positive and negative directions of the RY axis, respectively.

At this time, the orthogonal coordinate system is divided by axes L0, L45, L90, L135, L180, L225, L270 and L315 into eight regions AR1 to AR8 in 45° increments with respect to the origin point O. The region AR1 is defined by the axes L0 and L45 on the first quadrant, and the rest of the regions are called AR2, AR3, AR4, AR5, AR6, AR7 and AR8, respectively, in this order in a counterclockwise direction.

FIGS. 3 and 4 show (color) vector diagrams explaining an exemplary operation of the phase correction method, i.e., the phase correction circuit 2 according to the present embodiment. In this example, the phase correction circuit 2 performs phase correction on the vector V1 in the case where the vector V1 has an endpoint P1 within (i) the region AR3 or AR4 and (ii) a range of not more than a predetermined distance w from the axis L135.

More specifically, the phase correction circuit 2 moves the endpoint P1 of the vector V1 to be corrected to the side of the axis L135 for conversion into (a signal corresponding to) a vector V2 having an endpoint P2. In other words, the BY component b1 and the RY component r1 of the vector V1 are converted into a BY component b2 and an RY component r2 of the vector V2. Accordingly, the phase correction circuit 2 corrects the phase θ so that the vector V1 approaches the axis L135. An axis to which the endpoint P1 (in other words, components b1 and r1) is to be brought close is hereinafter referred to as “correction axis (or target axis)”.

Since the direction of the axis L135, i.e., the phase θ=135° almost corresponds to the direction of a color vector indicative of a skin color, this example allows a color (hue) in the neighborhood of the skin color to be corrected toward the skin color. Another color can also be corrected by selecting another axis such as L45 as correction axis.

In order to correct the phase θ as has been described, discrimination (or signal discrimination) needs to be executed as to whether or not the BY component b1 and the RY component r1 inputted to the phase correction circuit 2 are components of a signal which is a target of correction. In particular, the signal discrimination in the phase correction circuit 2 includes (I) phase discrimination as to whether or not the phase θ of the chroma signal c is present within a predetermined range of phase (more specifically, a region adjacent to the correction axis in the regions AR1 to AR8) and (II) distance discrimination as to whether or not the endpoint P1 of the vector V1 corresponding to the chroma signal c is present within a range of not more than a predetermined distance w (>0) from the correction axis (see FIGS. 3 and 4). The signal discrimination method in the phase correction circuit 2 will be described below with reference to the vector diagram of FIG. 2.

First or all, the first to fourth quadrants can be discriminated one from another in accordance with signs (positive or negative) of the components b1 and r1. Further, two regions in one quadrant can be discriminated as follows: since one quadrant is divided into two regions by 45°, the absolute values (i.e., magnitude) of components b1 and r1 differ between the two regions. For instance, FIGS. 3 and 4 show |b1|<|r1| in the region AR3 and |b1|>|r1| in the region AR4. Therefore, two regions in one quadrant can be discriminated in accordance with the relation between the absolute values |b1| and |r1 |.

To summarize the above, the regions AR1 to AR8 can be discriminated one from another in accordance with signs of the components b1, r1 and a value d (=|b1|−|r1|) obtained by subtracting the absolute value |r1| of the RY component r1 from the absolute value |b1| of the first component b1 of the BY component. That is, in the regions AR1 to AR8, the following relations hold:

AR1: b1>0, r1>0, |b1|−|r1|>0 (1)

AR2: b1>0, r1>0, |b1|−|r1|<0 (2)

AR3: b1<0, r1>0, |b1|−|r1|<0 (3)

AR4: b1<0, r1>0, |b1|−|r1|>0 (4)

AR5: b1<0, r1<0, |b1|−|r1|>0 (5)

AR6: b1<0, r1<0, |b1|−|r1|<0 (6)

AR7: b1>0, r1<0, |b1|−|r1|<0 (7)

AR8: b1>0, r1<0, |b1|−|r1|>0 (8)

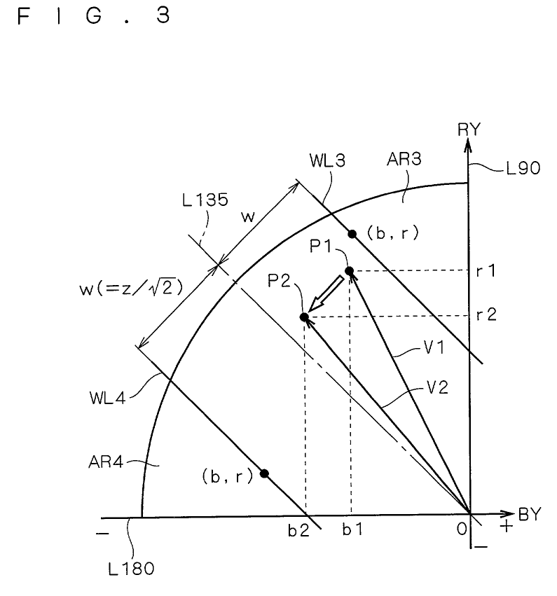

The relations (1) to (8) are shown in the vector diagram of FIG. 5, in which b1, r1 and d are shown by solid line when they have positive values and are shown by broken line when they have negative values.

Specifically, a difference between the absolute value |b1| of the BY component b1 and the absolute value |r1| of the RY component r1, i.e., values (|b1|−|r1|) and (|r1|−|b1|) are both referred to as “absolute-value difference”. For simplicity of explanation, the case will be mainly explained in which the absolute-value difference is the value d (=|b1|−|r1|) as described above, however, the above and the following explanation also applies to the case in which the absolute-value difference is the value (|r1|−|b1|).

Distance discrimination can be performed as will be described hereinafter. Explanation will be given referring to FIG. 3 as an example. Boundaries (lines) WL3 and WL4 shown in FIG. 3 are straight lines passing through the regions AR3 and AR4, respectively, in parallel to the axis L135 with the distance w (>0) therefrom. Indicating arbitrary points on the boundaries WL3 and WL4 by (b, r), the boundaries WL3 and WL4 are expressed as follows:

r=−b±w×{√(2)}

That is,

b+r=±w×{√(2)} (9)

At this time, arbitrary points within a region bewteen the boundaries WL3 and WL4 satisfy the following relation:

|b+r|<w×{√(2)} (10)

Since b1<0 and r1>0 in the second quadrant, the following expression

d=|b1|−|r1|=−b1−r1=−(b1+r1)

holds, and the absolute value |d| of the absolute-value difference d is given as follows:

|d1|=|b1+r1| (11)

According to the expressions (10) and (11), the endpoint P1 of the vector V1 satisfying the following relation (12) is present within the region between the boundaries WL3 and WL4.

|d|<w×{√(2)} (12)

The relation (12) holds when any one of the axes L45, L135, L225 and L315 is the correction axis. Therefore, the phase correction circuit 2 performs the distance discrimination in accordance with the relation (12) when the correction axis (or target axis) is any one of the axes L45, L135, L225 and L315. As has been described, the absolute value |d| of the absolute-value difference d corresponds to the distance w from the correction axis (or target axis) such as L135, which allows the distance discrimination to be facilitated.

Referring back to FIG. 1, a structure of the phase correction circuit 2 will be described below. The phase correction circuit 2 receives and corrects the BY component b1 and the RY component r1 to output the BY component b2 and the RY component r2. Here, the components b1, r1, b2 and r2 are n bit digital signals. When the phase is not corrected, the phase correction circuit 2 outputs the components b1 and r1 as the components b2 and r2.

More specifically, the phase correction circuit 2 includes an absolute-value difference arithmetic section 3, a component discriminating section 4 and a correction executing section 5. The absolute-value difference arithmetic section 3 (or an absolute-value difference arithmetic section 3A to be described later, or the like) and the component discriminating section 4 (or a component discriminating section 4C to be described later, or the like) form a signal discriminating section (or signal discriminating circuit) 6.

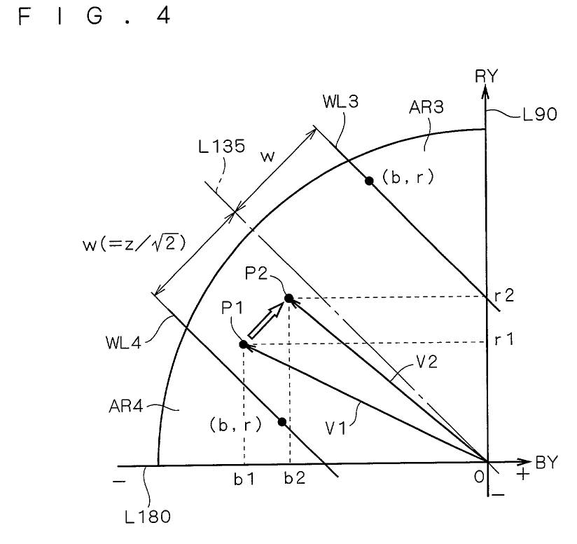

FIG. 6 is a block diagram showing the absolute-value difference arithmetic section 3. The absolute-value difference arithmetic section 3 obtains the BY component b1 and the RY component r1 to obtain the absolute-value difference d (=|b1|−|r1|) calculated by subtracting the absolute value |r1| of the RY component r1 from the absolute value |b1| of the BY component b1, thereby outputting the absolute-value difference d.

The absolute-value difference arithmetic section 3 includes two absolute value circuits (abbreviated to ABS in the drawing) 31, 32 and a subtracter 33. More specifically, the absolute value circuit 31 receives the BY component b1 to obtain and output the absolute value |b1| of the component b1. The absolute value circuit 32 receives the RY component r1 to obtain and output the absolute value |r1| of the component r1. The subtracter 33 receives the absolute values |b| and |r1| to obtain and output the absolute-value difference d (=|b1|−|r1|).

In accordance with the signs (positive or negative) of the two components b1 and r1, the absolute-value difference d is given as follows:

when b1>0, r1>0 (in the first quadrant),

d=b1−r1=dm (13)

when b1<0, r1>0 (in the second quadrant),

d=−b1−r1=−(b1+r1)=−dp (14)

when b1<0, r1<0 (in the third quadrant),

d=−b1−(−r1)=−(b1−r1)=−dm (15)

when b1>0, r1<0 (in the fourth quadrant),

d=b1−(−r1)=b1+r1=dp (16)

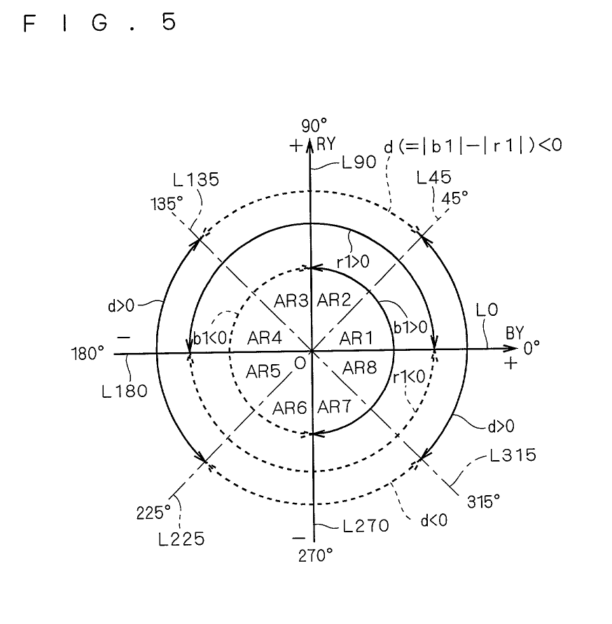

The expressions (13) to (16) show that the absolute-value difference d is given by (A) an addition value dp (=b1+r1) of the BY component b1 and the RY component r1, (B) a subtraction value dm (=b1−r1) obtained by subtracting the RY component r1 from the BY component b1 and (C) the signs (positive or negative) of the addition value dp and the subtraction value dm. In view of this point, the absolute-value difference arithmetic section 3A shown in the block diagram of FIG. 7 is applicable instead of the absolute-value difference arithmetic section 3 shown in FIG. 6.

As shown in FIG. 7, the absolute-value difference arithmetic section 3A includes an adder (or a first adder) 34, a subtracter (or a first subtracter) 35 and a selector 36. More specifically, the adder 34 obtains the BY component b1 and the RY component r1 to add these components, thereby outputting the addition value dp (=b1+r1). The subtracter 35 obtains the BY component b1 and the RY component r1 to subtract the RY component r1 from the BY component b1, thereby outputting the subtraction value dm (=b1−r1).

The selector 36 obtains the addition value dp, the subtraction value dm, the BY component b1 and the RY component r1 and outputs, as the absolute-value difference d, any one of the values dm, (−dp), (−dm) and dp given by the aforementioned expressions (13) to (16) in accordance with the signs of the components b1 and r1. The selector 36 generates the value (−dp) by reversing the sign of the addition value dp when b1<0 and r1>0 (the second quadrant), and generates the value (−dm) likewise from the subtraction value dm when b1<0 and r1<0 (the third quadrant). Accordingly, the absolute-value difference arithmetic section 3A obtains and outputs the absolute-value difference d.

In the absolute-value difference arithmetic sections 3 and 3A, the absolute-value difference d can be obtained with respect to an arbitrary vector V1 on the vector diagram, whereas it is possible to form an absolute-value arithmetic section applicable to a specific quadrant based on the absolute-value difference arithmetic section 3A.

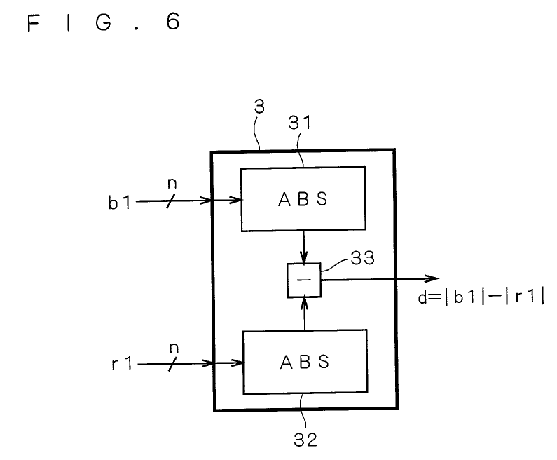

For instance, according to the above expression (14), the absolute-value difference d between the components b1 and r1 in the second quadrant is obtainable by adding the components b1 and r1 and reversing the signs (positive or negative) of the addition value dp (=b1+r1). In light of this point, an absolute-value difference arithmetic section 3B for the second quadrant can be structured as shown in the block diagram of FIG. 8.

More specifically, the absolute-value difference arithmetic section 3B includes the adder 34 and a sign reversing circuit 37. The adder 34 obtains and adds the components b1 and r1, thereby outputting the addition value dp (=b1+r1). Then, the sign reversing circuit 37 obtains the addition value dp and reverses the sign (positive or negative) of the addition value dp, thereby obtaining and outputting the absolute-value difference d. The sign reversing circuit 37 corresponds to the sign reversing function provided for the selector 36 shown in FIG. 7.

Likewise, an absolute-value arithmetic section for the first quadrant may be formed by the subtracter 35 (see the equation (13)), an absolute-value arithmetic section for the third quadrant may be formed by the subtracter 35 and the sign reversing circuit 37 (see the equation (15)) and an absolute-value arithmetic section for the fourth quadrant may be formed by the adder 34 (see the equation (16)). These structures may be used in combination.

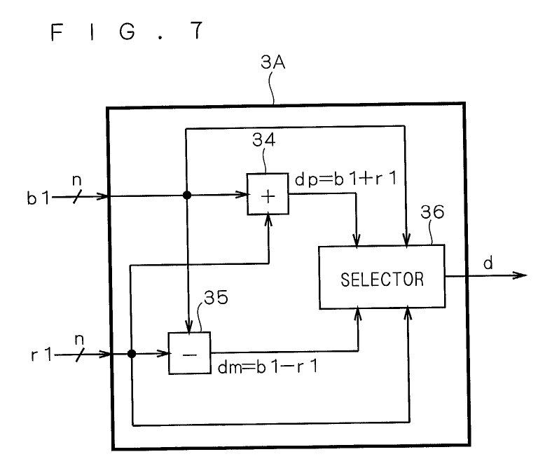

FIG. 9 is a block diagram showing the component discriminating section 4. The component discriminating section 4 executes the aforementioned signal discrimination, and more specifically, the phase discrimination and the distance discrimination. Accordingly, the component discriminating section 4 includes a phase discriminating section 41 and a distance discriminating section 42.

The phase discriminating section 41 obtains the BY component b1, the RY component r1 and the absolute-value difference d to execute the above-described phase discrimination using the signs of the components b1, r1 and the absolute-value difference d, thereby outputting a signal s415 indicative of a discrimination result.

More specifically, the phase discriminating section 41 includes a sign discriminating section 411 and a phase discrimination executing section 415. The sign discriminating section 411 includes three sign discrimination circuits (abbreviated to SGN in the drawing) 412 to 414. The sign discrimination circuit 412 obtains the component b1 to discriminate the sign (positive or negative) of the component b1, thereby outputting a discrimination result. Likewise, the sign discrimination circuit 413 discriminates the sign of the component r1 and outputs a discrimination result and the sign discrimination circuit 414 discriminates the sign of the absolute-value difference d all and outputs a discrimination result. The phase discrimination executing section 415 obtains the discrimination results from the sign discrimination circuits 412 to 414 to execute the aforementioned phase discrimination for the chroma signal c based on the relations (1) to (8), thereby outputting a discrimination result as the signal s415.

In this way, the phase discriminating section 41 uses the signs of the components b1, r1 and the absolute-value difference d, which allows the phase discrimination to be executed by 45° with respect to the origin point O.

The distance discriminating section 42 obtains the absolute-value difference d to perform the above-described distance discrimination using the absolute value |d| of the absolute-value difference d, thereby outputting a signal s422 indicative of a discrimination result.

More specifically, the distance discriminating section 42 includes an absolute value circuit 421 and a comparator (referred to as COMP in the drawing) (or comparing section) 422. The absolute value circuit 421 receives the absolute-value difference d to obtain, and output the absolute value |d| of the absolute-value difference d. The comparator 422 obtains the absolute value |d| outputted from the absolute value circuit 421 and a comparative reference value z (>0) to compare the relation between these values, thereby outputting the signal s422 indicative of a comparison result.

In particular, the following setting is made:

z=w×{√(2)}

and the comparative reference value z corresponds to the aforementioned distance w (see FIGS. 3 and 4).

The phase correction circuit 2 controls the correction executing section 5 by means of the two signals s415 and s422 (see FIG. 1).

As has been described, the component discriminating section 4, therefore, the signal discriminating section 6 can discriminate a signal to be corrected by means of the phase discrimination and the distance discrimination performed by the phase discriminating section 41 and the distance discriminating section 42, respectively. At this time, the signal discrimination (phase discrimination and distance discrimination) is executed using the absolute-value difference d and is therefore facilitated.

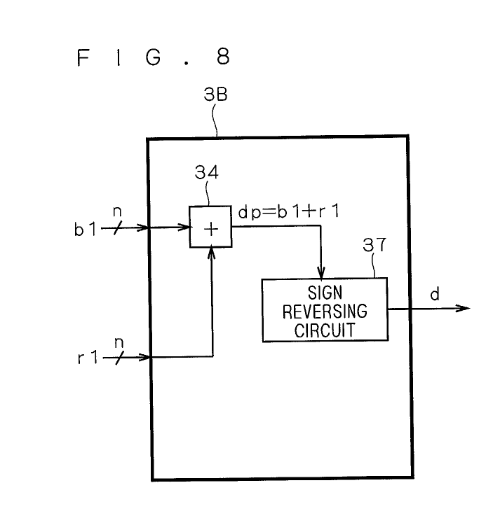

FIG. 10 is a block diagram showing the correction executing section 5. The correction executing section 5 obtains the BY component b1, the RY component r1, the absolute-value difference d, the signals s415 and s422 from the component discriminating section 4, and a correction coefficient α (|α|≦1, α is a fixed value here). Using these, the correction executing section 5 corrects the phase θ with respect to a signal to be corrected, and outputs the BY component and the RY component of the corrected signal as the BY component b2 and the RY component r2.

More specifically, the correction executing section 5 includes a correction amount arithmetic section 51 and a correction signal generating section 52. The correction amount arithmetic section 51 includes a multiplier 511. The multiplier 511 (therefore, the correction amount arithmetic section 51) obtains the absolute-value difference d, the signals s415 and s422, and the correction coefficient α. Then, when the signals s415 and s422 both indicate that an inputted chroma signal c should be corrected, the multiplier 511 multiplies the absolute-value difference d by the correction coefficient α to obtain and output the correction amount β (=α×d).

The correction signal generating section 52 obtains the correction amount β, the components b1 and r1 to output the BY component b2 and the RY component r2. At this time, when the inputted chroma signal c is a signal to be corrected, the correction signal generating section 52 corrects the components b1 and r1 using the correction amount β, thereby outputting the components b2 and r2 obtained by the correction.

Explanation will be given below on the correction signal generating section 52 in the case where the correction axis is L135, as an example (see FIGS. 3 and 4). In this example, the correction coefficient α is set as 0≦α≦1, and the relations d, β<0 and d, β>0 hold in the regions AR3 and AR4, respectively. In this case, the correction signal generating section 52 is formed by two adders (or second adders) 521 and 522. The adder 521 obtains the BY component b1 and the correction amount β to add these values, thereby outputting the addition value as the BY component b2 (b2=b1+β). Likewise, the adder 522 obtains the RY component r1 and the correction amount β to add these values, thereby outputting the addition value as the RY component r2 (r2=r1+β). Since β<0 in the region AR3 and β>0 in the region AR4 as described above, the correction signal generating section 52 allows the components b1 and r1 to approach the correction axis L135.

In the case where either of the signals s415 and s422 indicates that the inputted chroma signal is not a target of correction, the correction amount arithmetic section 51 sets the correction amount β=0 by setting the correction coefficient α=0. Thereby, the correction signal generating section 52 outputs the components b1 and r1 as the components b2 and r2. In this way, the correction executing section 5 corrects the phase θ of a signal which is a target of correction as required.

According to the equations (13) to (16), the absolute-value difference d is given by either of the values dp, dm and the values (−dp) and (−dm) having signs reversed to those of the values dp and dm. At this time, using the values dp and dm, the relations (1) to (8) are expressed as follows:

AR1: b1>0, r1>0, dm>0 (17)

AR2: b1>0, r1>0, dm<0 (18)

AR3: b1<0, r1>0, dp>0 (19)

AR4: b1<0, r1>0, dp<0 (20)

AR5: b1<0, r1<0, dm<0 (21)

AR6: b1<0, r1<0, dm>0 (22)

AR7: b1>0, r1<0, dp<0 (23)

AR8: b1>0, r1<0, dp>0 (24)

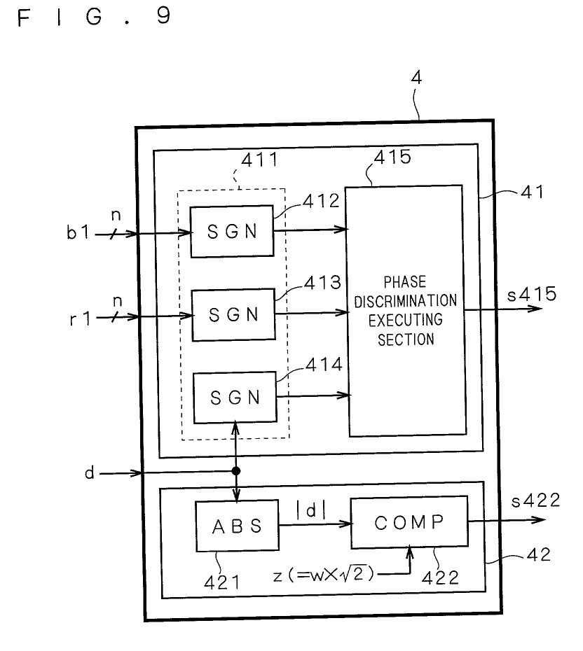

The relations among these expressions (17) through (24) are shown in the vector diagram of FIG. 11. In FIG. 11, the values b1, r1, dm and dp are represented by solid lines when they are positive and represented by broken lines when negative. In the second quadrant, for example, the regions AR3 and AR4 are discriminated on the basis of the sign of the value (−dp) according to the expressions (3) and (4), while these regions can be discriminated on the basis of the sign of the addition value dp according to the expressions (19) and (20).

In the component discriminating section 4, the comparing section 422 obtains the absolute value of the absolute-value difference. Thus, the aforementioned structure shows, in FIG. 9 is applicable to the comparing section 422 using either of the values dp and (−dp).

Therefore, the component discriminating section 4, more specifically, the phase discrimination executing section 415 is constructed in such a manner as to execute the phase discrimination in accordance with the expressions (17) to (24), which allows to eliminate the necessity of generating the values (−dp) and (−dm) at the absolute-value difference arithmetic section 3A shown in FIG. 7.

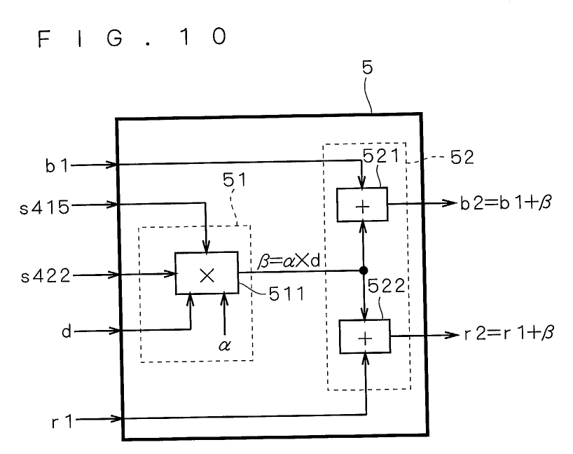

In light of the foregoing, an absolute-value difference arithmetic section 3C for the second quadrant shown in FIG. 12 can be employed instead of the absolute-value difference arithmetic section 3B for the second quadrant shown in FIG. 8. The absolute-value difference arithmetic section 3C has a structure in which the sign reversing circuit 37 is removed from the absolute-value difference arithmetic section 3B, and outputs the addition value dp as the absolute-value difference d.

At this time, in light of the sign of the absolute-value difference d (the value dp, not (−dp) in this case) outputted from the absolute-value difference arithmetic section 3C, the correction executing section 5 shown in FIG. 10 is applicable to the absolute-value difference arithmetic section 3C shown in FIG. 12 by reversing the sign of the correction coefficient α (i.e., setting the coefficient as −1≦α≦0), for example.

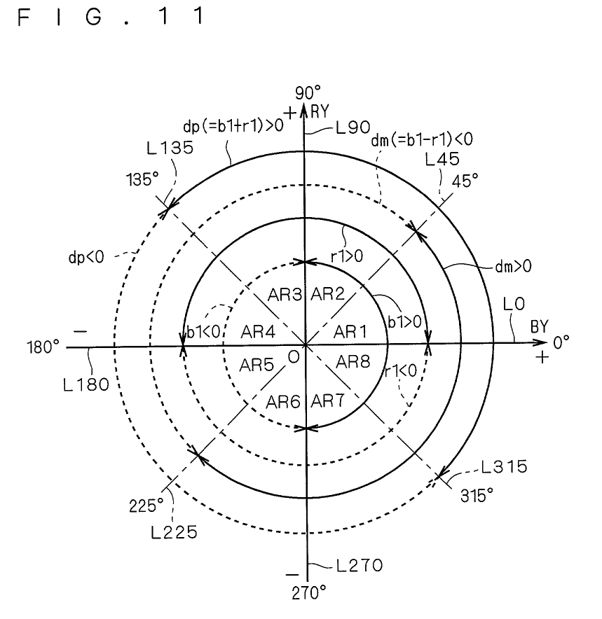

Alternatively, a correction executing section 5A shown in FIG. 13, for example, may be applied to the absolute-value difference arithmetic section 3C. The correction executing section 5A includes subtracters (or second subtracters) 523 and 524 instead of the adders 521 and 522 in the correction executing section 5 shown in FIG. 10. The subtracter 523 obtains the BY component b1 and the correction amount β and subtracts the correction amount β from the component b1, thereby outputting the subtraction value as the BY component b2 (b2=b1−β). Likewise, the subtracter 524 obtains the RY component r1 and the correction amount β and subtracts the correction amount β from the component r1, thereby outputting the subtraction value as the RY component r2 (r2=r1−β). At this time, the relation 0≦α≦1 holds in the correction executing section SA as in the correction executing section 5.

In the case where the correction axis is any one of the axes L0, L90, L180 and L270, the adder 521 or 522 and the subtracter 523 or 524 are combined to form the correction signal generating section 52.

Now in light of the fact that the other absolute-value difference (|r1|−|b1|)=−d, the difference arithmetic section 3C shown in FIG. 12 and the correction executing section 5A shown in FIG. 13 can be considered as being derived from the case where the absolute-value difference is (|r1|−|b1|).

As has been described, the phase correction circuit 2 corrects the phase θ of an inputted chroma signal c using the absolute-value difference d. At this time, the absolute-value difference is basically obtainable by means of addition (adder) and/or subtraction (subtracter). Further, since the correction amount β is obtained by multiplying the absolute-value difference d by the correction coefficient α no complicated formula is used. Besides, the signal discriminating section 6 uses the absolute-value difference d. This facilitates the phase correction method and the signal discrimination method performed by the phase correction circuit 2, and allows the phase correction circuit 2 and the signal discriminating section 6 to be provided on a small circuit scale.

Likewise, the correction signal generating section 52 at the correction executing section 5 includes the adders 521, 522 and/or the subtracters 523 and 524. Thus, the correction signal generating section 52 can also be provided on a small circuit scale.

<Second Preferred Embodiment>

Explanation has been given on the case where the correction coefficient α is a fixed value in the first preferred embodiment. Such a setting of the correction coefficient may cause great discreteness (discontinuity) between a signal already corrected and a signal not corrected in the vicinity of the boundaries WL3 and WL4 shown in FIGS. 3 and 4, for example. This discreteness becomes more noticeable as the correction coefficient α is greater. Therefore, in this second preferred embodiment, explanation will be given on a phase correction method and a phase correction circuit capable of reducing such discreteness (discontinuity) between signals. Taken as an example is the case where the correction axis is L135.

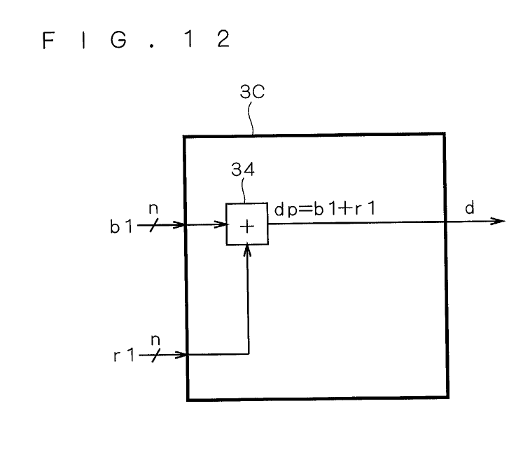

FIG. 14 is a vector diagram showing a phase correction method according to the present embodiment. As is apparent from comparison between FIGS. 14 and 3, the distance w from the correction axis L135 is divided into four in the correction method of this embodiment. More specifically, boundaries (lines) WL31, WL32 and WL33 in parallel to the correction axis L135 are defined between the correction axis L135 and the boundary WL3 on the vector diagram. Distances between the correction axis L135 and each of the boundaries WL31, WL32, WL33 and WL3 are represented by w1, w2, w3 and w4, respectively. Here, the relation 0<w1<w2<w3<w4 (=w=z/{√(2)}) holds, and the boundaries WL31, WL32 and WL33 are provided in this order from the correction axis L135. The boundaries WL31, WL32, WL33 and WL3 may be positioned at regular intervals or at different intervals from one another.

The region AR3 is divided into five regions AR31 to AR35 by the correction axis L135 and the boundaries WL3 and WL31 to WL33. The five regions AR31 to AR35 are provided in this order from the correction axis L135.

Likewise, boundaries (lines) WL41, WL42 and WL43 are provided in correspondence with the boundaries (lines) WL31, WL32 and WL33, respectively, to divide the region AR4 into five regions AR41 to AR45 corresponding to the regions AR31 to AR35, respectively. For the simplicity of explanation, distances between the correction axis L135 and each of the boundaries WL41, WL42, WL43 and WL4 are represented by w1, w2, w3 and w4, respectively.

Particularly in the phase correction method according to the present embodiment, the correction coefficient α is varied depending in which of the regions AR31 to AR35 and AR41 to AR45 an endpoint P1 of a vector V1, i.e., the BY component b1 and the RY component r1 are present. At this time, the correction coefficient α having a smaller absolute value is provided for a region more distant from the correction axis L135. That is, the correction coefficient α having a smaller absolute value is provided for an endpoint P1 more distant from the correction axis L135 by each of the regions AR31 to AR35 and AR41 to AR45. For instance, the coefficient α is set as follows:

AR31, AR41: α=0.875

AR32, AR42: α=0.625

AR33, AR43: α=0.375

AR34, AR44: α=0.125

AR35, AR45: α=0.000

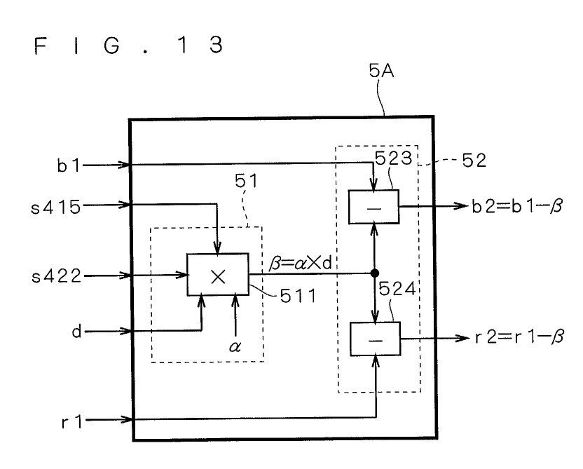

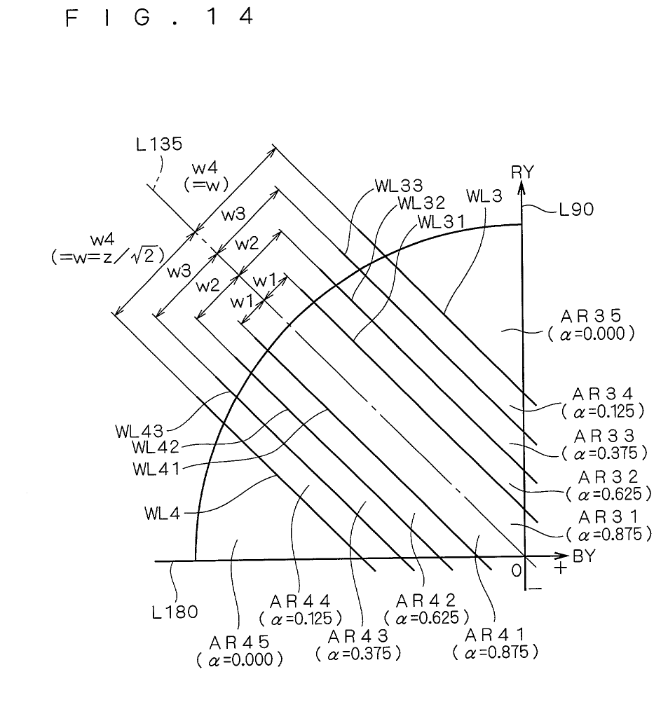

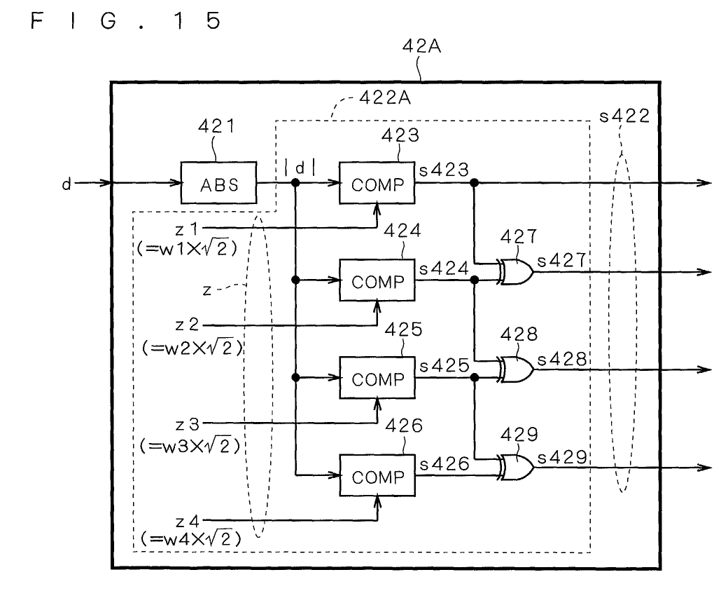

Next, explanation will be given on a phase correction circuit capable of achieving the above-described phase correction method. FIGS. 15 and 17 are block diagrams showing a distance discriminating section 42A and a correction executing section 5B to be applied to the phase correction circuit according to the present embodiment. The phase correction circuit includes the distance discriminating section 42A instead of the distance discriminating section 42 and the correction executing section 5B instead of the correction executing section 5A in the phase correction circuit 2 shown in FIG. 1 (see FIGS. 15 and 17). FIG. 16 is a schematic signal waveform chart showing an operation of the distance discriminating section 42A. In FIG. 16, levels of signals s423 to s429 (to be described later) are represented by binary digits “0” and “1” for the sake of convenience.

As shown in FIG. 15, the distance discriminating section 42A obtains the absolute-value difference d and, using the absolute value |d| thereof, executes the distance discrimination as to whether or not the endpoint P1 of the vector V1 corresponding to an inputted signal is present within a range of the predetermined distances w1 to w4 from the correction axis L135 (in other words, in which of the regions AR31 to AR35 and AR41 to AR45 the endpoint P1 is present). The distance discriminating section 42A then outputs the signals s423 and s427 to s429 indicative of discrimination results. The signals s423 and s427 to s429 correspond to the aforementioned signal s422.

More specifically, the distance discriminating section 42A includes an absolute value circuit 421 and a comparing section 422A. The absolute value circuit 421 receives the absolute-value difference d to obtain and output the absolute value |d| of the absolute value difference d.

The comparing section 422A includes four comparators 423 to 426 and three exclusive OR circuits 427 to 429. For example, the comparator 423 obtains the absolute value |d| outputted from the absolute value circuit 421 and a comparative reference value z1 (=w1/{√(2)}>0) to compare the relation between these values, thereby outputting a comparison result as the signal s423. The comparator 423 outputs the signal s423 at the level of “1” when it is judged that the absolute value |d| is smaller than the comparative reference value z1 (corresponding to the case where the distance between the endpoint P1 of the vector V1 and the correction axis L135 is smaller than the distance w1). When the absolute value |d| is larger than the comparative reference value z1, the signal s423 is at the level of “0”.

Likewise, the comparators 424, 425 and 426 obtain the absolute value |d| of the absolute-value difference d and comparative reference values z2, z3 and z4, respectively, to compare the relation between the absolute value |d| and each comparative reference value, thereby outputting comparison results as the signals s424, s425 and s426 at the level of “1” or “0”. Here, the relations z2=w2/{√(2)}(>0), z3=w3/{√(2)}(>0) and z4=w4/{√(2)}(>0) hold, and the comparative reference values z1 to z4 correspond to the above-described comparative reference value z.

Further, the exclusive OR circuit 427 obtains the two signals s423 and s424 to output an exclusive OR of these signals as the signal s427. Likewise, the exclusive OR circuit 428 outputs an exclusive OR of the two signals s424 and s425 as the signal s428, and the exclusive OR circuit 429 outputs an exclusive OR of the two signals s425 and s426 as the signal s429.

At this time, the signal s423 corresponds to the regions AR31 and AR41, and is at the level of “1” when the components b1 and r1 of the inputted chroma signal c (i.e., the endpoint P1 of the corresponding vector V1) are present within the regions AR31 and AR41. Likewise, the signal s427 corresponds to the regions AR32 and AR42, the signal s428 corresponds to the regions AR33 and AR43, and the signal s429 corresponds to the regions AR34 and AR44. When the components b1 and r1 of the inputted chroma signal c are present within the regions AR35 and AR45, the signals s423 and s427 to s429 are all at the level of “0”.

FIG. 16 shows the case where the signals s423 to s426 are all at the level of “1”. Such waveforms are obtained when the distance between the endpoint P1 of the vector V1 and the correction axis L135 is smaller than the distance w1, in other words, when the endpoint P1 is present within the region AR31 or AR41. FIG. 16 also shows the signals s427 to s429 in correspondence with the signals s423 to s426.

As shown in FIG. 17, the phase correction circuit 2 of the present embodiment controls the correction executing section 5B by means of the signals s415, s423 and s427 to s429.

The correction executing section 5B includes a correction amount arithmetic section 51B instead of the correction amount arithmetic section 51 in the correction executing section 5 shown in FIG. 10. The correction executing section 5B obtains the BY component b1, the RY component r1, the absolute-value difference d, the signals s415, s423 and s427 to s429, thereby outputting the BY component b2 and the RY component r2. The correction amount arithmetic section 51B includes a multiplier 511 and a correction coefficient output section 512. The correction coefficient output section 512 obtains the signals s423 and s427 to s429 to output the correction coefficient α having a predetermined value based on the signals s423 and s427 to s429.

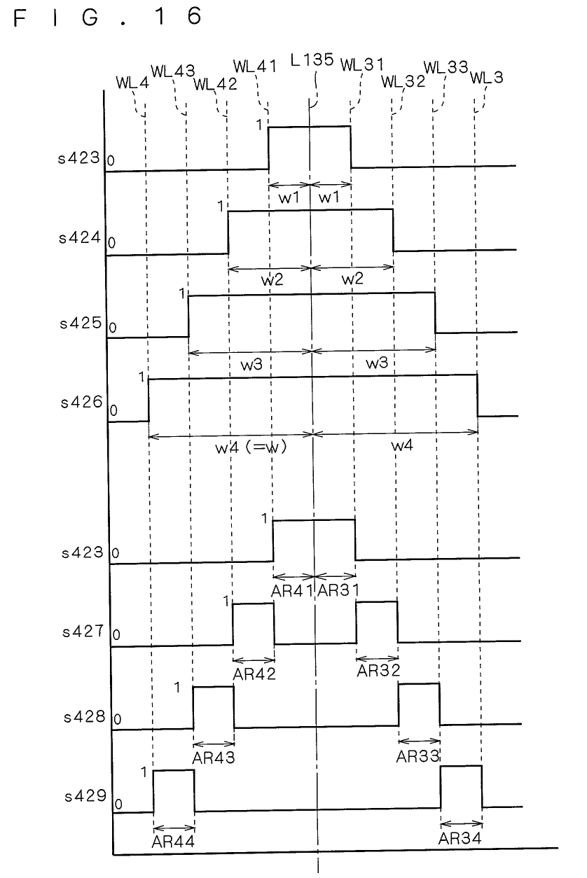

FIG. 18 schematically shows an operation of the correction coefficient output section 512. Since the signal s423 or the like corresponds to the regions AR31, AR41 or the like, the correction coefficient output section 512 outputs a predetermined value as the correction coefficient a according to the level of the signals s423 and s427 to s429. The word “x” in FIG. 18 represents an arbitrary level.

More specifically, the correction coefficient output section 512 outputs the correction coefficient α=0.875 when the signal s423 is at the level of“1”, the correction coefficient α=0.625 when the signal s427 is at the level of “1”, the correction coefficient α=0.375 when the signal s428 is at the level of “1”, and the correction coefficient α=0.125 when the signal s429 is at the level of “1”. When the signals s423 and s427 to s429 are all at the level of “0”, the correction coefficient output section 512 outputs the correction coefficient α=0.000. In short, the correction coefficient output section 512 outputs the correction coefficient α of a smaller absolute value corresponding to a greater one of the comparative reference values z1 to z4. The correction coefficient output section 512 has the relations as shown in FIG. 18 in the form of a table, for example. The correction coefficient output section 512 may be structured in such a manner as to obtain a value of the correction coefficient α by means of a functional formula or the like having the signals s423 and s427 to s429 as parameters.

In this way, the correction coefficient α can be made variable in the distance discriminating section 42A and the correction executing section 5B in accordance with the signals s423 to s426 corresponding to comparison results made by the comparator 422A (or the signals s423 and s427 to s429 obtained from the signals s423 to s426).

The multiplier 511 obtains the absolute-value difference d, the signal s415 and the correction coefficient α outputted from the correction coefficient output section 512. When the signal s415 indicates that an inputted signal should be corrected, the multiplier 511 multiplies the absolute-value difference d by the correction coefficient α to obtain and output the correction amount β(=α×d).

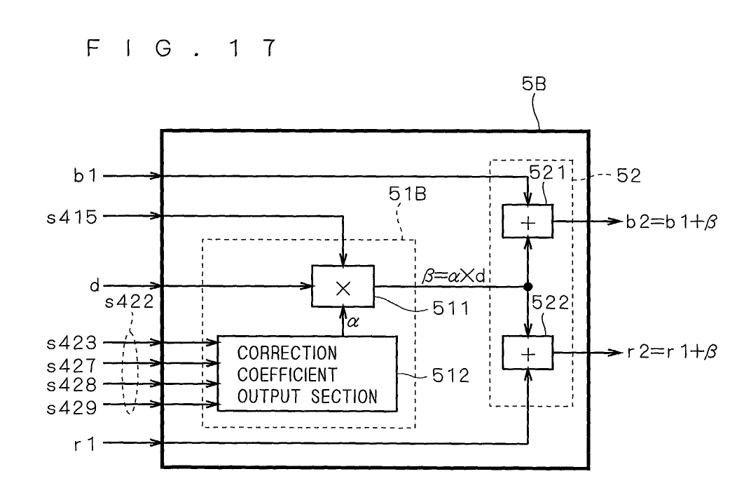

As shown in the vector diagram of FIG. 19, two regions between the correction axis L135 and the boundaries WL3 and WL4 may be divided into seven, respectively. In this case, the correction coefficient α is set, for example, as 0.875, 0.750, 0.675, 0.500, 0.375, 0.250, 0.125 and 0.000 in this order from the closest regions (corresponding to the regions AR31 and AR41 shown in FIG. 14) to the correction axis L135.

Although explanation has been given on the case where L135 is the correction axis in the second preferred embodiment, the distance discriminating section and the correction executing section may also be structured similarly in the case where the correction axis is L45, for example.

In the phase correction circuit and the phase correction method achieved thereby according to the second preferred embodiment, the correction coefficient α, therefore, the correction amount β can be made variable in accordance with the distance between the endpoint P1 of the vector V1 and the correction axis L135 or the like. This enables reduction of discreteness (discontinuity) between a chroma signal c that is not a target of correction and a corrected chroma signal c. At this time, the correction coefficient α has a smaller absolute value corresponding to a greater one of the comparative reference values z1 to z4, in other words, corresponding to a greater one of the predetermined distances w1 to w4. Therefore, the absolute value of the correction coefficient α, therefore, that of the correction amount β can be smaller as the endpoint P1 of the vector V1 is more distant from the correction axis L135 or the like. This can ensure minimization of discreteness between the above-described signals.

<First Variation>

Although the above-described phase correction circuit 2 and the like control the correction amount arithmetic sections 51 and 51B by means of the signal s422 or the signals s423 and s427 to s429, a structure to be described below may be applied thereto.

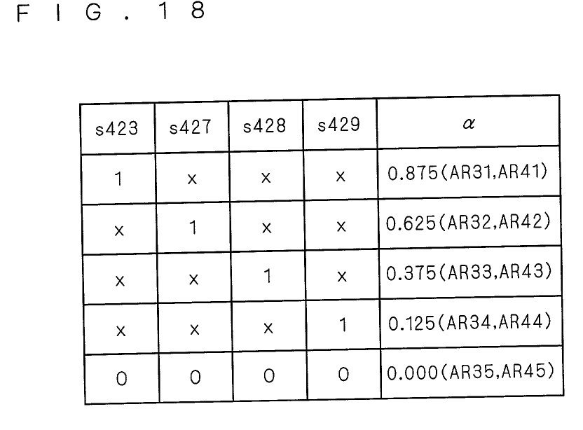

FIG. 20 is a block diagram explaining a phase correction circuit according to the first variation. FIG. 20 shows a distance discriminating section 42B and the correction amount arithmetic section 51, and other structures are similar to the phase correction circuit 2 shown in FIG. 1, and the like.

The distance discriminating section 42B has a comparing section 422B instead of the comparing section 422 in the distance discriminating section 42 shown in FIG. 9. The comparing section 422B compares the relation between the absolute value |d| and the comparative reference value z similarly to the comparing section 422. Specifically, the comparing section 422B (in other words, the distance discriminating section 42B) outputs the correction coefficient α as a comparison result. For instance, referring to FIG. 3, the comparing section 422B outputs the correction coefficient α having a predetermined value (>0) in the case where the distance between the endpoint P1 of the vector V1 and the correction axis L135 is not larger than the distance w, and outputs the correction coefficient α=0 in other cases.

The distance discriminating section 42B may be structured by providing the correction coefficient output section 512 shown in FIG. 17 within the distance discriminating section 42A shown in FIG. 15.

In response to the distance discriminating section 42B structured as described-above, the multiplier 511 in the correction amount arithmetic section 51 obtains the absolute-value difference d, the correction coefficient α and the signal s415, thereby outputting the correction amount β(=α×d).

<Second Variation>

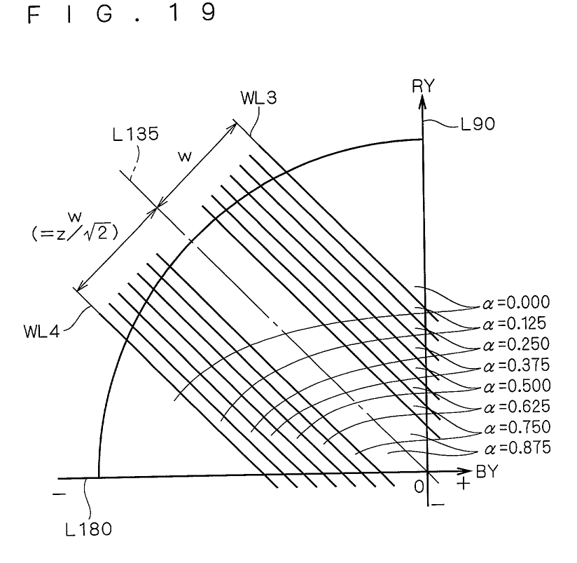

FIG. 21 is a block diagram showing the component discriminating section 4C according to this second variation. As is apparent from comparison with the component discriminating section 4 shown in FIG. 9, the component discriminating section 4C has the phase discriminating section 41 and the distance discriminating section 42 provided in series, for serially executing the phase discrimination and the distance discrimination.

More specifically, the signal s415 from the phase discriminating section 41 is inputted to the distance discriminating section 42. When the signal s415 indicates that an inputted chroma signal c has been judged as not being a target of correction by the phase discrimination, the distance discriminating section 42 does not execute the distance discrimination. At this time, the distance discriminating section 42 outputs the signal s422 indicating that the inputted chroma signal c is not a target of correction in the distance discrimination. On the other hand, when the signal s415 indicates to the contrary, the distance discriminating section 42 executes the distance discrimination and outputs a discrimination result as the signal s422.

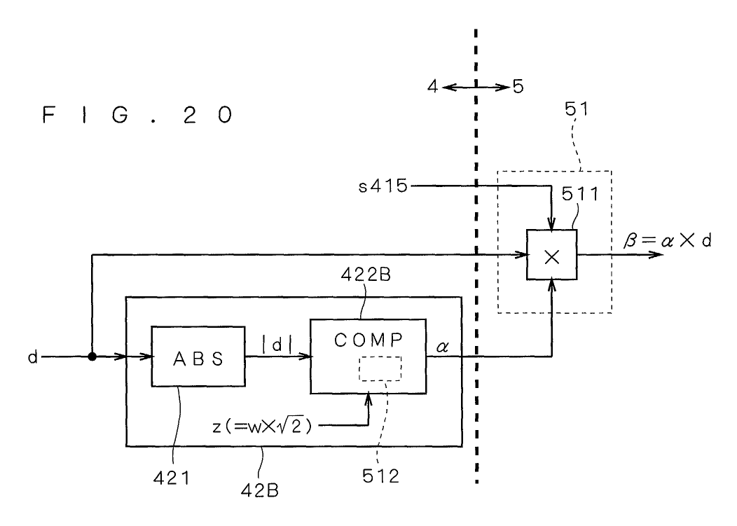

FIG. 22 is a block diagram showing another component discriminating section 4D according to this second variation. The component discriminating section 4D has the phase discriminating section 41 and the distance discriminating section 42 provided in series in the opposite order to that in the component discriminating section 4C shown in FIG. 21.

More specifically, in the component discriminating section 4D, the signal s422 from the distance discriminating section 42 is inputted to the phase discriminating section 41. Then, when the signal s422 indicates that an inputted chroma signal c has been judged as not being a target of correction by the distance discrimination, the phase discriminating section 41 does not execute the phase discrimination. At this time, the phase discriminating section 41 outputs the signal s415 indicating that the inputted chroma signal c is not a target of correction in the phase discrimination, whereas, when the signal s422 indicates to the contrary, the phase discriminating section 41 executes the phase discrimination and outputs a discrimination result as the signal s415.

Various types of structures are possible, for example by applying the distance discriminating sections 42A and 42B to the component discriminating sections 4C and 4D instead of the distance discriminating section 42.

In the first and second preferred embodiments and the first and second variations, explanation has been given on the case where the signal discriminating section or the signal discriminating circuit 6 (see FIG. 1) includes both of the phase discriminating section and the distance discriminating section, however, only one of these sections may be used as necessary. For instance, when the correction axis is one of the axes L0, L90, L180 and L270, the distance discriminating section 42 is not used.

<Third Variation>

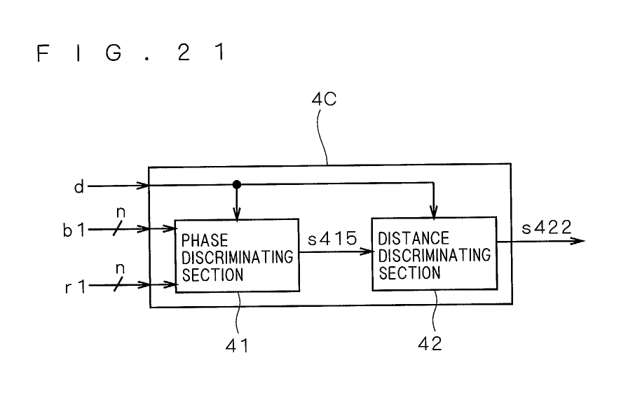

Contrary to the above explanation, the RY axis, the BY axis, the RY component and the BY component may be set as the first coordinate axis, the second coordinate axis, the first component and the second component, respectively. Further, another orthogonal coordinate system may be used. For example, an orthogonal coordinate system may be used which is defined by so-called Q axis and I axis shown in the (color) vector diagram of FIG. 23. The Q axis and the I axis are inclined 33° and 123° toward the BY axis, respectively, and are orthogonal to each other. Furthermore, as a matter of course, the above-described phase correction circuit, the phase correction method, the signal discrimination circuit and the signal discrimination method are applicable to a general signal.

While the invention has been shown and described in detail, the foregoing description is in all aspects illustrative and not restrictive. It is therefore understood that numerous modifications and variations can be devised without departing from the scope of the invention.

What is claimed is:

1. A phase correction circuit for correcting a phase of a signal, wherein said signal is represented on a vector diagram of an orthogonal coordinate system having first and second coordinate axes by a signal vector having a first component on said first coordinate axis and a second component on said second coordinate axis,
said phase correction circuit comprising:
an absolute-value difference arithmetic section for obtaining an absolute-value difference corresponding to a difference between an absolute value of said first component and that of said second component; and
a correction executing section for correcting said phase of said signal using said absolute-value difference, wherein
said correction executing section includes:
a correction amount arithmetic section for multiplying said absolute-value difference by a correction coefficient to obtain a correction amount; and
a correction signal generating section for correcting said phase of said signal using said correction amount and said first and second components.

2. The phase correction circuit according to claim 1, wherein
said absolute-value difference arithmetic section includes at least one of a first adder adding said first and second components and a first subtracter calculating a difference between said first and second components, and
said absolute-value difference arithmetic section obtains said absolute-value difference using at least one of an addition value obtained by said first adder and a subtraction value obtained by said first subtracter.

3. The phase correction circuit according to claim 1, wherein
said correction signal generating section includes either of a second adder adding said correction amount to said first or second component and a second subtracter subtracting said correction amount from said first or second component.

4. The phase correction circuit according to claim 1, further comprising
a component discriminating section for executing signal discrimination as to whether or not said phase of said signal should be corrected using said absolute-value difference, thereby controlling said correction executing section based on a result of said signal discrimination.

5. The phase correction circuit according to claim 4, wherein
said component discriminating section includes a comparing section for comparing the relation between an absolute value of said absolute-value difference and at least one comparative reference value.

6. The phase correction circuit according to claim 5, wherein
said at least one comparative reference value includes a plurality of comparative reference values, and
said correction coefficient is variable in accordance with a comparison result given by said comparing section.

7. The phase correction circuit according to claim 6, wherein
said correction coefficient has a smaller absolute value corresponding to a greater one of said plurality of comparative reference values.

8. The phase correction circuit according to claim 4, wherein
said component discriminating section includes a sign discriminating section for discriminating signs of said first and second components and said absolute-value difference, and
said component discriminating section executes said signal discrimination using said signs of said first and second components and said absolute-value difference.

9. The phase correction circuit according to claim 4, wherein
said signal discrimination includes at least one of phase discrimination as to whether or not said phase of said signal is present within a predetermined range of phase and distance discrimination as to whether or not an endpoint of said signal vector is present within a range of a predetermined distance from a correction axis.

10. The phase correction circuit according to claim 9, wherein
said predetermined distance includes a plurality of distances, and
said correction coefficient has a smaller absolute value corresponding to a greater one of said plurality of distances.

11. The phase correction circuit according to claim 1, wherein
said signal includes a chroma signal, and
said first coordinate axis includes a BY axis and said second coordinate axis includes an RY axis.

12. A signal discriminating circuit for discriminating a signal, wherein
said signal is represented on a vector diagram of an orthogonal coordinate system having first and second coordinate axes by a signal vector having a first component on said first coordinate axis and a second component on said second coordinate axis,
said signal discrimination circuit comprising:
an absolute-value difference arithmetic section for obtaining an absolute-value difference corresponding to a difference between an absolute value of said first component and that of said second component; and
a component discriminating section for executing signal discrimination as to whether or not said first and second components of said signal are present within a predetermined range using said absolute-value difference.

13. The signal discrimination circuit according to claim 12, wherein
said component discriminating section includes a comparing section for comparing the relation between an absolute value of said absolute-value difference and at least one comparative reference value.

14. The signal discrimination circuit according to claim 12, wherein
said component discriminating section includes a sign discriminating section for discriminating signs of said first and second components and said absolute-value difference, and
said component discriminating section executes said signal discrimination using said signs of said first and second components and said absolute-value difference.

15. The signal discrimination circuit according to claim 13, wherein
said component discriminating section includes a sign discriminating section for discriminating signs of said first and second components and said absolute-value difference, and
said component discriminating section executes said signal discrimination using said signs of said first and second components and said absolute-value difference.

16. The signal discrimination circuit according to claim 12, wherein
said signal discrimination includes at least one of phase discrimination as to whether or not said phase of said signal is present within a predetermined range of phase and distance discrimination as to whether or not an endpoint of said signal vector is present within a range of a predetermined distance from a correction axis.

17. A signal discrimination method of discriminating a signal, wherein
said signal is represented on a vector diagram of an orthogonal coordinate system having first and second coordinate axes by a signal vector having a first component on said first coordinate axis and a second component on said second coordinate axis,
said signal discrimination method comprising the steps of:
(a) obtaining an absolute-value difference corresponding to a difference between an absolute value of said first component and that of said second component; and
(b) executing signal discrimination as to whether or not said first and second components of said signal are present within a predetermined range using said absolute-value difference.

18. The signal discrimination method according to claim 17, further comprising the step of
(c) comparing the relation between an absolute value of said absolute-value difference and at least one comparative reference value.

19. The signal discrimination method according to claim 17, further comprising the step of
(d) discriminating signs of said first and second components and said absolute-value difference, wherein
said step (b) includes the step of
(b-1) executing said signal discrimination using said signs of said first and second components and said absolute-value difference.
